(19) United States
(12) Patent Application Publication
(10) Pub. No.: US 2009/0219544 A1
(43) Pub. Date: Sep. 3, 2009

(54) SYSTEMS, METHODS AND COMPUTER-ACCESSIBLE MEDIUM FOR PROVIDING SPECTRAL-DOMAIN OPTICAL COHERENCE PHASE MICROSCOPY FOR CELL AND DEEP TISSUE IMAGING

(75) Inventors: Chulmin Joo, Schenectady, NY (US); Johannes F. De Boer, Amstelveen (NL)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 12/205,277

(22) Filed: Sep. 5, 2008

Related U.S. Application Data
(60) Provisional application No. 60/970,157, filed on Sep. 5, 2007.

(51) Int. Cl. G01J 3/45; G01B 9/02

(52) U.S. Cl. 356/456; 356/451

(57) ABSTRACT

Exemplary arrangement, apparatus, method and computer accessible can be provided. For example, using the exemplary arrangement, apparatus and method, it is possible to configured to propagate at least one electro-magnetic radiation. Indeed, it is possible to receive, using at least one first arrangement, a first portion of the at least one electro-magnetic radiation directed to a sample and a second portion of the least one electro-magnetic radiation directed to a reference, the first arrangement can be structured to at least partially reflect and at least partially allow to transmit the first and second portions. In addition, it is possible to receive, using a second arrangement, (i) a third portion of the electro-magnetic radiation associated with at least one of the transmitted first portion or the reflected first portion from the sample and (ii) a fourth portion of the electro-magnetic radiation associated with at least one of the second transmitted portion of the least one electro-magnetic radiation or the reflected second portion from the reference. The third and fourth portions can travel at least partially along substantially the same path toward the second arrangement, Further, the second arrangement can be configured to receive the reflected first and second portion(s) which interfere with one another, and generate at least one signal which includes information associated with at least one fluctuation in an uncommon path of the first and second portions prior to a receipt thereof by the at least one first arrangement. In addition or alternatively, the second arrangement can be configured to determine information regarding a spectrally resolved interference associated with the third and fourth portions.

### CROSS-REFERENCE TO RELATED APPLICATION(S)

The present invention relates to U.S. Provisional Application No. 60/970,157 filed Sep. 5, 2007, the entire disclosure of which is incorporated herein by reference.

### FIELD OF THE INVENTION

The present invention relates to systems, methods and computer-accessible medium for providing spectral-domain optical coherence phase microscopy for cell and deep tissue imaging. In particular, exemplary embodiments of the systems, methods and computer-accessible medium can be provided for optical imaging capable of highly sensitive amplitude and phase imaging of cellular and tissue specimens by use of a low-coherence spectral interferometer.

### BACKGROUND INFORMATION

Optical coherence tomography (“OCT”), Spectral Domain OCT and Optical Frequency Domain Imaging (“OFDI”) are imaging techniques that can measure the interference between a reference beam of light and a measurement beam reflected or returned back from a sample. A detailed system description of traditional time-domain OCT was first described in D. Huang et al., “Optical Coherence Tomography,” Science 254: 1178 (1991). Detailed descriptions for spectral-domain OCT and optical frequency domain imaging (OFDI) systems are provided in U.S. patent application Ser. Nos. 10/501,276 and 10/577,562, respectively, the entire disclosures of which are incorporated herein by reference.

Spectral-domain optical coherence phase microscopy (“SD-OCPM”), a functional extension of spectral-domain OCT (as described in A. F. Fercher et.al., “Measurement of intraocular distances by backscattering spectral interferometry”, Optics Comm 117:43 (1998); N. Nassif et.al, “In vivo human retical imaging by ultrahigh-speed spectral domain optical coherence tomography”, Optics Lett. 29:480 (2003); and Park et.al., “Real-time fiber-based multi-functional spectral-domain optical coherence tomography at 1.3 μm”, Optics Express 13:3931 (2005)), has been developed for providing quantitative amplitude and phase imaging of cellular specimens. Unlike conventional spectral-domain OCT, SD-OCPM generally employs a common-path low-coherence interferometer, where the bottom surface of a cover slip acts as a reference (see M. A. Choma et.al, “Spectral-domain phase microscopy”, Optics Lett. 30:1162 (2005); C. Joo et.al., “Spectral-domain optical coherence phase microscopy for quantitative phase-contrast imaging”, Optics Lett. 30:2131 (2005)). Such common-path configuration can facilitate a nanometer-level phase stability for biological specimens. Detailed descriptions describing the exemplary principle of operation and system implementation of SD-OCPM can be found in C. Joo, et al. “Spectral-domain optical coherence phase microscopy for quantitative phase-contrast imaging,” Optics Letters 30:2131 (2005); and C. Joo, et al. “Spectral Domain optical coherence phase and multiphoton microscopy,” Optics Letters 32:623 (2007).

Though SD-OCPM is capable of generating quantitative amplitude and phase images of transparent materials and cellular specimens, the imaging depth obtained therewith can be limited to tens of microns. For high-resolution imaging of thick samples, this technique likely requires a volumetric scan of a focal volume inside the specimens generated by a high numerical-aperture objective. This focal volume has a short depth-of-focus, and a confocal detection as in SD-OCPM rejects the light reflected from the reference surface. If the focus is located deep into the specimen, the light from the reference surface would likely be too low to generate an interference with the light scattered from the focal volume.

Other phase sensitive imaging methods and techniques for deep tissue specimens by use of low-coherence interferometers have been described, but have at least some phase instability of the separate beam interferometer configuration. Examples of such methods and techniques include Polarization-sensitive OCT (see J. F. de Boer et.al., “Two-dimensional birefringence imaging in biological tissue by polarization-sensitive optical coherence tomography,” Optics Letters. 22, 934-936 (1997)) and Doppler OCT (see Z. Chen et.al., “Noninvasive imaging of in vivo blood flow velocity using optical Doppler tomography,” Optics Letters. 22, 1119-1121 (1997); S. Yazdanfar et. al, “Imaging and velocimetry of the human retinal circulation with color Doppler optical coherence tomography,” Optics Letters. 25, 1448-1450 (2000); and B. H. Park et.al, “Real-time fiber-based multi-functional spectral-domain optical coherence tomography at 1.3 μm,” Optics Express. 13, 3931-3944 (2005)).

Dynamic light scattering (“DLS”), also known as Quasi-elastic Light Scattering (“QELS”) and Photon Correlation Spectroscopy (“PCS”), are known techniques for measuring translational, rotational, and internal motions of small particles of sizes over a range of a few nanometers to a few microns in suspension (see P. J. Berne and R. Pecora, “Dynamic Light Scattering” 1976, New York: Wiley; and D. A. Boas et.al., “Using dynamic low-coherence interferometry to image Brownian motion within highly scattering media,” Optics Letters. 23:319 (1998)). With DLS, a coherent source of light (such as laser) can be directed at the moving particles. Light scattered by the particles at a particular detection angle to the incident beam can be collected and measured at a detector where photons are converted to electrical pulses. Particles undergoing Brownian motion can modulate the amplitude and phase of the scattered light, thus causing fluctuations in the scattered light intensity. This fluctuation in scattered light intensity has a time scale that is related to the speed of the movement of the particles, and information about the sample properties can be extracted from the power spectrum or temporal correlation function of the detected signal.

Conventional DLS, however, is likely limited to low spatial resolution and low sensitivity to nanometer-scale scatterer motion. Thus, DLS has not been applied to investigating nanometer-scale biological processes inside cells and tissues.

There may be a need to overcome certain deficiencies associated with the conventional arrangements and methods described above.

### SUMMARY OF EXEMPLARY EMBODIMENTS OF THE PRESENT INVENTION

To address and/or overcome such deficiencies, exemplary embodiments of the present invention can be provided.

In general, certain exemplary embodiments of the systems, methods and computer-accessible medium according to the present invention can facilitate high-resolution imaging based on the interferometric detection of scattered light from the sample.

For example, exemplary embodiments of the present invention can provide the systems, methods and computer-accessible medium which can facilitate high-sensitive measurement and imaging of structural variations deep in the biological sample based on phase-stable low coherence interferometer. Such exemplary embodiments can be applied to functional implementations associated with the motion of structures at a particular depth location. Moreover, by scanning the beam in a volumetric space, the exemplary embodiments of the present invention can generate three-dimensional intensity, phase, and diffusive property images of biological specimens.

According to one exemplary embodiment of the present invention, the source beam from a broad band light source or rapid wavelength tunable light source can be separated into two separately collimated beams with different diameter before entering the microscope. The large diameter beam (e.g., the sample beam) can be tightly focused in the sample with a short depth of focus. The small diameter beam (e.g., the reference beam) can generate a focused beam with a significantly larger depth of focus. Such beam can provide enough back-reflected light from an out-of-focus reference surface (e.g., the bottom or top surface of a cover slip) to act as a reference in the common path interferometer. However, the separation of the beam into two beam paths can generate a phase instability, since the two beams generally do not share a common path. To address this issue, a glass slide or partially reflective surface can be inserted in the beam path after the beams are recombined. This exemplary glass slide or partially reflective surface can generates an interference between the beams that propagate via the separate paths. By monitoring this interference term, phase instabilities due to the separate paths can be quantified and corrected for.

According to another exemplary embodiment of the present invention, quantitative amplitude and phase images within the sample can be obtained by examining the corresponding complex interference signals. The light reflected from the interfaces along the beam path and from the focal volume likely interferes, and the interference spectrum can be measured by a spectrometer. Taking a Fourier transform of the interference spectrum can yield depth-resolved complex-valued information, where it is possible to locate the interference signals of interest. Recording and mapping the magnitude and phase of this complex signal while scanning the beam in three-dimensional space may generate 3D amplitude and phase images.

According to yet another exemplary embodiment of the present invention, a quantitative characterization of localized diffusive and directional processes within the sample can be accomplished by performing a field-based dynamic light scattering (“F-DLS”) analysis. Such F-DLS analysis can involve a calculation of a temporal autocorrelation function of a time series of complex-valued interference signal at a particular location. The magnitude and phase information of the complex-valued autocorrelation function can provide information regarding diffusive properties and directional motion of structures within the sample.

There are several aspects of certain exemplary embodiments of the present invention that can make it a beneficial procedure for three-dimensional (3D) biological imaging. For example, such exemplary embodiments can:
Provide a reliable and stable phase determination of a depth location deep in the sample can be achieved with a single measurement of the interference spectrum;
Be implemented into a pre-existing SD-OCPM system by adding an optical arrangement that can generate, e.g., two beams with different beam diameters in the beam path before the microscope;
Facilitate three-dimensional amplitude and quantitative phase imaging of biological specimens;
Facilitate a field-based dynamic light scattering, which provides a localized measurement of the diffusive and directional processes within the sample; and
Applicable to other variants of OCT, such as polarization-sensitive OCT and Doppler OCT.

Thus, exemplary arrangement, apparatus, method and computer accessible can be provided. For example, using the exemplary arrangement, apparatus and method, it is possible to configured to propagate at least one electro-magnetic radiation. Indeed, it is possible to receive, using at least one first arrangement, a first portion of the at least one electro-magnetic radiation directed to a sample and a second portion of the least one electro-magnetic radiation directed to a reference, the first arrangement can be structured to at least partially reflect and at least partially allow to transmit the first and second portions.

In addition, it is possible to receive, using a second arrangement, (i) a third portion of the electro-magnetic radiation associated with at least one of the transmitted first portion or the reflected first portion from the sample and (ii) a fourth portion of the electro-magnetic radiation associated with at least one of the second transmitted portion of the least one electro-magnetic radiation or the reflected second portion from the reference. The third and fourth portions can travel at least partially along substantially the same path toward the second arrangement, Further, the second arrangement can be configured to receive the reflected first and second portion(s) which interfere with one another, and generate at least one signal which includes information associated with at least one fluctuation in an uncommon path of the first and second portions prior to a receipt thereof by the at least one first arrangement. In addition or alternatively, the second arrangement can be configured to determine information regarding a spectrally resolved interference associated with the third and fourth portions.

According to one exemplary variant, the electro-magnetic radiation can be generated by a broadband electromagnetic radiation source and/or by an electromagnetic radiation source that has a tunable center wavelength. The second arrangement may be further configured to receive the reflected first and/or second portions which interfere with one another, and generate at least one signal which includes information associated with at least one fluctuation in an uncommon path of the first and second portions prior to a receipt thereof by the first arrangement.

The second arrangement may further be configured to determine information regarding a spectrally resolved interference associated with the third and fourth portions. In addition, at least one third arrangement can be provided which may be configured to vary an angle of incidence of the electromagnetic radiation on the sample. Further, a waist of the first portion that is focused within the sample can be about 0.5 μm or less. The second arrangement may be further configured to (i) receive the reflected first and/or second portions which interfere with one another, and generate the signal prior to the receipt thereof by the first arrangement, and (ii) determine the information regarding the spectrally resolved interference associated with the third and fourth portions.

According to another exemplary embodiment of the present invention, computer-accessible medium (e.g., storage device, such as, hard drive, floppy drive, RAM, ROM, removable storage device, memory stick, etc.) can be provided which may include instructions, For example, when the instructions are executed by a processing arrangement, the processing arrangement performs certain procedures. Such exemplary procedures can include (i) receiving first data associated with at least one electromagnetic radiation which is an interference between a first radiation obtained from a sample and a second radiation obtained from a reference, and (ii) based on the first data, determining second data associated with a directional displacement of at least one object within the sample and third data associated with at least one diffusion property of the object.

In one exemplary variant, the processing arrangement can generate the second data and/or the third data as a function of a time scale associated with a motion of the object. In addition, the processing arrangement can generate the second and third data by an auto-correlation of the first data. Further, the first radiation can be provided at a first location within the sample. The processing arrangement can receive further data associated with the electromagnetic radiation which is an interference between a further radiation obtained from the sample and a second radiation at a second location within the sample which is different from the first location. Further, the processing arrangement can generate the second and third data based on the first and further data. The second and third data may be generated by a cross correlation between the first data and the further data. The processing arrangement can resolve the directional displacement of the object at the first and second locations as a function of time.

In another exemplary variant, the second data can be determined based on a time correlation of a velocity of the object within the sample. The processing arrangement may generate at least one signal which can include information associated with at least one fluctuation in an uncommon path of the first and second radiations. Further, the processing arrangement can determine information regarding a spectrally resolved interference associated with the further data.

According to still another exemplary embodiment of the present invention, computer-accessible medium (e.g., storage device, such as, hard drive, floppy drive, RAM, ROM, removable storage device, memory stick, etc.) can be provided which may include instructions to execute procedures by a processing arrangement for imaging at least one portion of a sample. For example, such exemplary procedures can include (i) receiving data associated with at least one electromagnetic radiation which is an interference between a first radiation obtained from a sample and a second radiation obtained from a reference, and (ii) based on the data, generating at least one image associated with a directional displacement of at least one object within the sample and at least one diffusion property of the object.

In one exemplary variant, each object is native to the sample. In addition, a waist of the first radiation that is focused within the sample can be about 0.5 μm or less. The processing arrangement can generate the image by scanning the sample laterally and axially using the first radiation. Further, the image can be a two-dimensional image, a three-dimensional image and/or a four-dimensional image. For example, one of dimensions of the two, three or four-dimensional image can be time. The second data may be determined based on a time correlation of a velocity of the object within the sample. Additionally, the processing arrangement can generate at least one signal which can include information associated with at least one fluctuation in an uncommon path of the first and second radiations prior to a receipt thereof by at least one arrangement which may be configured to at least partially reflect and at least partially allow to transmit the first and second radiations. Further, the processing arrangement can determine information regarding a spectrally resolved interference associated with the data.

According to still another exemplary embodiment of the present invention, computer-accessible medium (e.g., storage device, such as, hard drive, floppy drive, RAM, ROM, removable storage device, memory stick, etc.) can be provided which may include instructions to execute procedures by a processing arrangement for imaging at least one portion of a sample. For example, such exemplary procedures can include (i) receiving data associated with at least one electromagnetic radiation which is an interference between a first radiation obtained from a living organism and a second radiation obtained from a reference, and (ii) based on the data, generating at least one image associated with at least one diffusion property of the living organism in which each object is native.

In one exemplary variant, the second data may be determined based on a time correlation of a velocity of the object within the sample. In addition, the processing arrangement can generate at least one signal which includes information associated with at least one fluctuation in an uncommon path of the first and second radiations prior to a receipt thereof by at least first arrangement which can be configured to at least partially reflect and at least partially allow to transmit the first and second radiations. Further, the processing arrangement can determine information regarding a spectrally resolved interference associated with the data.

According to yet a further exemplary embodiment of the present invention, computer-accessible medium (e.g., storage device, such as, hard drive, floppy drive, RAM, ROM, removable storage device, memory stick, etc.) can be provided which may include instructions to execute procedures by a processing arrangement. For example, such exemplary procedures can include (i) receiving first data associated with at least one electromagnetic radiation which is an interference between a first radiation obtained from a sample and a second radiation obtained from a reference, and (ii) based on the first data, determine second data associated with changes within the sample using a power spectrum of the at least one electromagnetic radiation based on an auto-correlation function.

In one exemplary variant, the second data can be determined based on a time correlation of a velocity of at least one object within the sample. In addition, the processing arrangement can generate at least one signal which includes information associated with at least one fluctuation in an uncommon path of the first and second radiations prior to a receipt thereof by at least first arrangement which can be configured to at least partially reflect and at least partially allow to transmit the first and second radiations. Further, the processing arrangement can determine information regarding a spectrally resolved interference associated with the data

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a diagram of an exemplary embodiment of a spectral domain OCPM (“SD-OCPM”) arrangement in accordance with the present invention which utilizes a light from a reference arm and a sample arm with different diameters;

FIG. 2 is a diagram of another exemplary embodiment of SD-OCPM arrangement in accordance with the present invention which utilizes the light only from sample arm and a beam splitting/combining unit which is configured to generate two beams with different diameters;

FIG. 3 is a diagram of an exemplary embodiment of a beam splitting/combining arrangement according to the present invention which can be based on Wollaston prisms and lenses that can be utilized in the exemplar arrangement shown in FIG. 3;

FIG. 4 is an illustration of an exemplary operational measurement in accordance with an exemplary embodiment of the present invention which illustrates reference and sample reflections in the sample path for a dual beam common-path interferometer;

FIG. 5 is a flow diagram of an exemplary embodiment of a method for amplitude and phase measurements according to the present invention;

FIG. 6 is a flow diagram of an exemplary embodiment of the method for a field-based dynamic light scattering according to the present invention;

FIGS. 7A and 7B are exemplary SD-OCPM amplitude and phase images, respectively, recorded by an exemplary embodiment of the arrangement according to the present invention;

FIG. 8 is a collection of graphs showing exemplary results of the phase stability measured by the exemplary embodiment of the arrangement shown in FIG. 2;

FIGS. 9A-9D are graphs showing exemplary results of the F-DLS analysis on intralipid particles undergoing Brownian and direction motions measured by an exemplary embodiment of the arrangement according to the present invention; and

FIG. 10 is a graph showing exemplary results of the F-DLS analysis on ovarian cancer cells examining velocity correlation under different physiological conditions in accordance with an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention.

### DETAILED DESCRIPTION OF EXEMPLARY EMBODIMENTS

Thus, certain exemplary embodiments of the present invention can provide an imaging system, method and computer-accessible medium, using which the light reflected from the sample can be used to characterize and image a structural variation inside the sample with a high level of sensitivity.

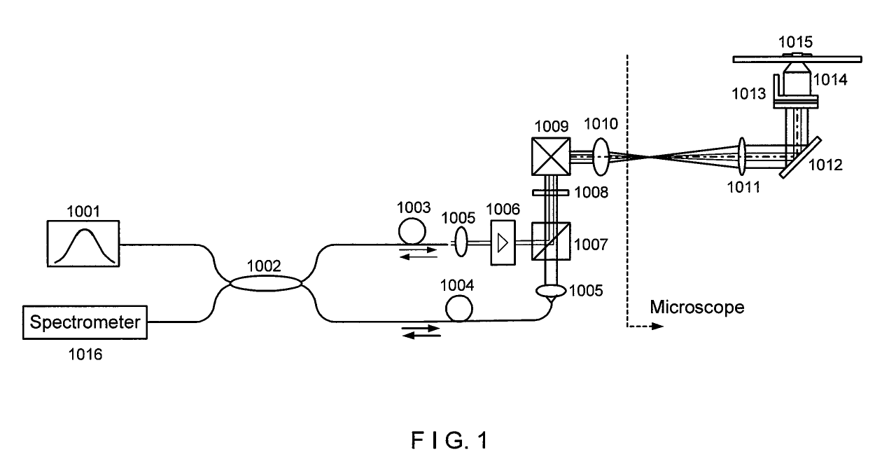

According to one exemplary embodiment of the arrangement according to the present invention shown in FIG. 1, light from a broadband light source (1001) can be separated by a 2×2 fiber coupler (1002). The light from a reference arm (1003) and a sample arm (1004) can be collimated via collimators (1005) with difference/different focal lengths to generate the beams with different beam diameters with respect to one another. Such two beams can then be combined at a beamsplitter (1007), scanned by a beam scanning devices (1009), and introduced into a microscope. The beams can be magnified by a telescope composed of scan and tube lenses (1010, 1011), and focused onto a specimen/sample (1015) through an objective lens (1014). The larger diameter sample beam can be tightly focused in the sample with a diffraction-limited spatial resolution. The small diameter reference beam will create a focused beam with a much larger depth of focus.

The reflected light from the interfaces along the beam path and from the sample (1015) may be re-coupled into the fiber coupler, and the interference spectrum there between can be measured by a spectrometer (1016). A glass slide or a partially reflecting surface (1008) which can be inserted before the microscope may generate interference between the beams that have propagated along separate paths. By monitoring this interference term, phase instabilities due to the separate paths can be quantified and corrected for. An isolator (1006) provided after the reference arm fiber can be utilized to eliminate light coupling into the fiber of the reference (1003).

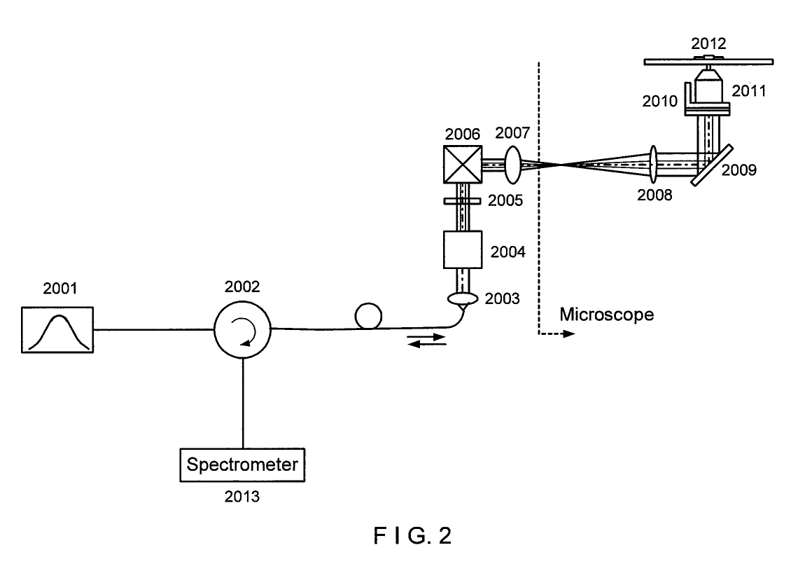

In another exemplary embodiment of the arrangement according to the present invention as shown in FIG. 2, light from a broadband light source (2001) can be provided to the microscope using a circulator (2002). The light emitted from the fiber can be collimated by a collimator (2003), which then passes through a beam splitting/combining unit (2004) so as to generate two or more beams with different diameters for the reference and sample lights. The beams can then pass through a glass slide (2005) provided for phase reference and beam scanning device (2006), and may subsequently be introduced into the microscope. Other exemplary components can include scan and tube lenses (2007, 2008), a deflecting mirror (2009), a piezo-electric transducer (2010), a microscope objective (2011), and a spectrometer (2013).

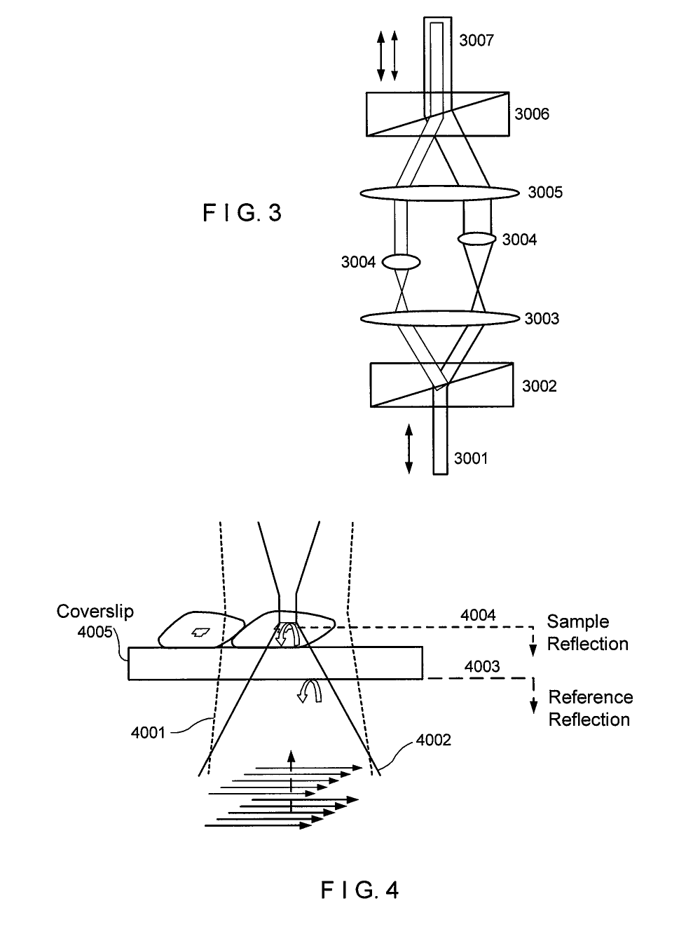

In an exemplary embodiment of a beam splitting/combining unit according to the present invention as shown in FIG. 3, a collimated beam (3001) can be separated into two or more beams with a different polarization state using a Wollaston prism (3002). Such two beams can then be magnified in a different ratio by a combination of lenses (3003, 3004), and recombined at another Wollaston prism (3006). The smaller beam can serve as a reference light.

FIG. 4 shows an illustration of an exemplary operational measurement in accordance with an exemplary embodiment according to the present invention using the exemplary arrangement of FIG. 1. For example, the smaller diameter reference beam can be focused into a beam with a long depth-of-focus (4001) so that it may provide a strong reference reflection from the bottom surface of a coverslip (4003). The large diameter sample beam (4002), on the other hand, can be focused into the sample with a diffraction-limited spatial resolution, and the reflected/returned light from the focus (4004) can interfere with the reference light.

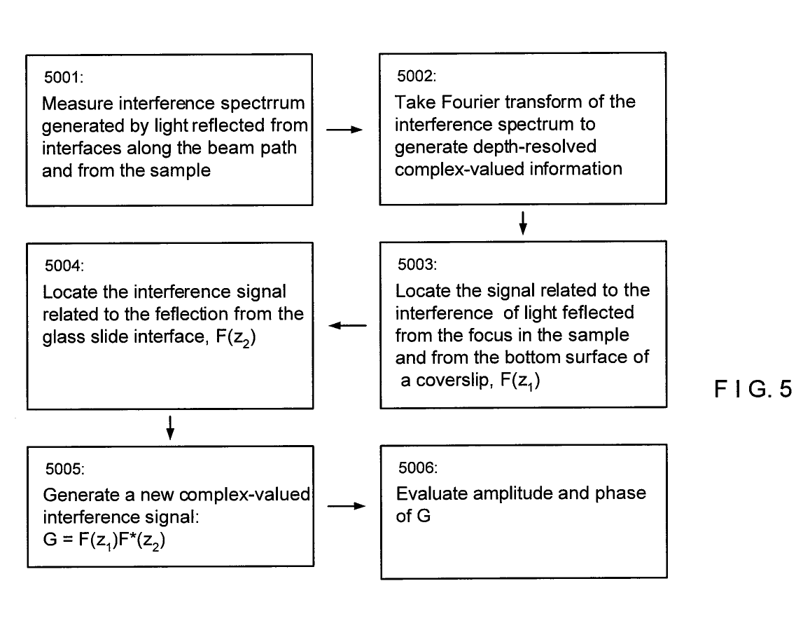

FIG. 5 illustrates a flow diagram of an exemplary embodiment of a method for amplitude and phase measurement/imaging according to the present invention using the exemplary arrangement shown in FIG. 1. For example, at the spectrometer (1016), the interference spectrum (procedure 5001) may be expressed as:

I(k)=2\sqrt{RᵣRₛ(z)}S(k)cos(2kΔp), (1)

where k is the wave number, z is the geometrical distance along the depth direction, and Rᵣ and Rₛ (z) represent the reference reflectivity and measurement reflectivity at depth z, respectively. S(k) is the power spectral density of the source, and Δp is the optical path length difference between the reference and measurement beams. A complex-valued depth information F(z) (procedure 5002) can be obtained by a discrete Fourier transform of Eq. (1) with respect to 2k, and thus the intensity and phase at depth z can be obtained as:

$$\begin{matrix}I ( z ) = {\vert F ( z ) \vert}^{2} , & ( 2 ) \\ φ ( z ) = {tan}^{- 1} [ \frac{Im ( F ( z ) )}{Re ( F ( z ) )} ] = 2 \frac{2 π}{{λ}_{0}} Δ p ( z ) , & ( 3 )\end{matrix}$$

where λ₀ is the center wavelength of the source. The depth-resolved intensity information in Eq. (2) is used to locate specific interference signals of interest and to measure the corresponding amplitude of the signal. The phase obtained by Eq. (3) provides information on structural variation with a nanometer-scale sensitivity.

For the exemplary arrangements shown in FIGS. 1 and 2, another complex interference signal can be further generated by G=F(z₁)F*(z₂), where F(z₁) represents the complex signal related to the interference between the light from the focus and the bottom surface of the coverslip (procedure 5003), and F(z₂) denotes the signal related to the interference of reference and sample light reflected from the glass slide surface (procedure 5004). The exemplary amplitude and phase information of G (procedure 5005) can be used to measure localized structural variation inside the measurement volume. The three-dimensional amplitude and phase images may be constructed by performing the exemplary procedures described herein, whereas the optical focus can be scanned in the 3D space;

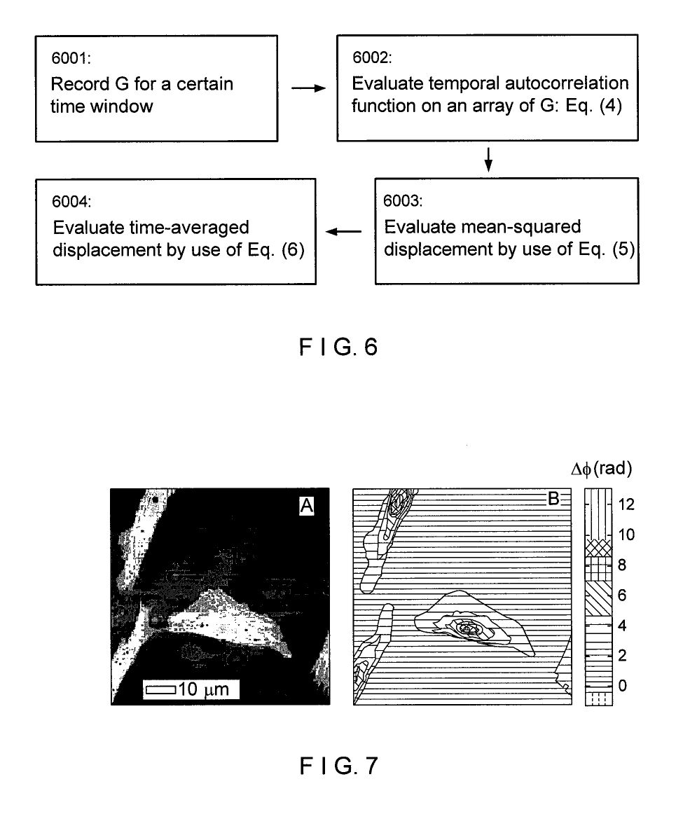

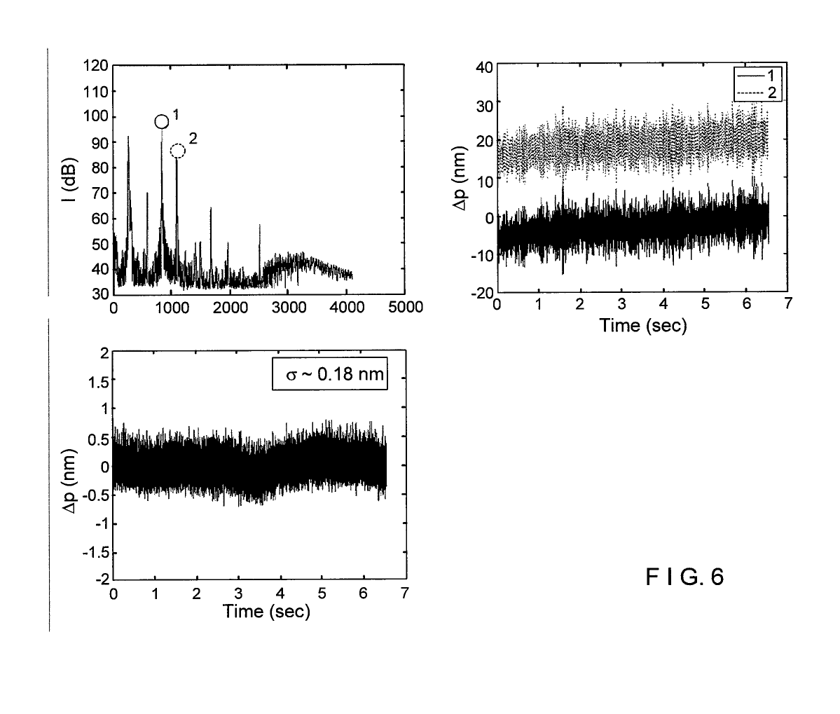

FIG. 6 is a flow diagram of an exemplary embodiment of a method for field-based dynamic light scattering according to the present invention. For example, the diffusive properties and directional/random motion of scatterers inside the measurement volume can be examined by field-based dynamic light scattering. Such procedure can utilize a calculation of the temporal autocorrelation function of the full complex-valued signal related to the interference between light scattered from focal volume inside a specimen and light reflected from the reference surface. Given a time source measurement of complex interference signal, G, at a particular depth (recorded in procedure 6001), a normalized temporal autocorrelation (procedure 6002) function can be given by:

$$R ( τ ) = exp [ - \frac{{q}^{2} {σ}^{2} ( τ )}{2} ] exp ( iq \cdot μ ( τ ) ) , \qquad ( 4 )$$

where q is the scattering vector, μ(τ) is time-averaged displacement (“TAD”) of the structures in τ, and σ²(τ) is time-averaged displacement variance, respectively (see C. Joo et.al., “Field-based dynamic light scattering for quantitative investigation of intracellular dynamics”, in preparation). The phase of R(τ) can facilitate an extraction of a time-averaged displacement, or μ(τ), as:

$$μ ( τ ) = \frac{{tan}^{- 1} ( R ( τ ) )}{q} . \qquad ( 5 )$$

The mean-squared displacement defined by MSD(τ)= [symbol] (z(t+τ)−z(t))² [symbol] (procedure 6003) can be obtained from:

$$MSD ( τ ) = {σ}^{2} ( τ ) + {μ}^{2} ( τ ) \\ = - \frac{ln ( R ( τ ) {R}^{*} ( τ ) )}{{q}^{2}} + {[ \frac{{tan}^{- 1} ( R ( τ ) )}{q} ]}^{2} . \qquad ( 6 )$$

Because of the likely unavailability of phase information, conventional DLS procedures can provide only the first term on the right hand side of Eq. (6) (procedure 6004). F-DLS procedures, on the other hand, can facilitate an extraction of TADs and the correction to the MSD by adding the second term in Eq. (6), which can modify the MSD evaluation for non-random motions of particles. TAD provides the information of directional/random motion in the sample, and MSD facilitates the extraction of diffusive properties in the measurement volume.

According to an exemplary embodiment of the method related to field-based dynamic light scattering according to the present invention, the coherence of particle motions inside the measurement volume can be examined by determining the temporal autocorrelation function of velocity. Time-averaged velocity profile can be evaluated by taking the first derivative of TAD as v(τ)=dμ(τ)/dτ

The determination of the temporal autocorrelation of v(τ)

v(Δτ)=∫v(τ)v(τ+Δτ)dτ (7)

Can facilitate a quantitative examination of the coherence of the directional motion as a function of time-delay.

### Exemplary Supporting Data

I. Phase Stability Characterization

An exemplary embodiment of the system, method and computer-accessible medium according to the present invention can be utilized to perform amplitude and quantitative phase imaging of cellular specimens. For example, FIGS. 7A and 7B show the exemplary amplitude and phase images of prepared muntjac skin fibroblast cells (FluoCells #6, Invitrogen, CA), respectively, recorded at a depth of ˜2 μm above the top surface of a coverslip. The scalebar denotes 10 μm, and the grayscale to the right of the phase image represents the phase distribution across the specimen. The phase image clearly shows higher phase delay in the nuclei. To provide supporting information for the exemplary embodiment of the present invention, the following experiment has been performed.

II. Amplitude and Phase Imaging of Cellular Specimen

To provide the supporting information for the exemplary embodiment of the present invention, the following experiment was performed. An exemplary configuration of the exemplary embodiment of the arrangement shown in FIG. 1 was constructed, except for the presence of the glass slide in the beam path after recombination of reference and sample beams and the isolator in the reference arm. Instead of the glass slide, a cover slip in the focal point of the microscope objective was used. The bottom surface of the cover slip acted as the reflective surface described above. The interference between top and bottom surface is the signal of interest. FIG. 8 shows a graph of the exemplary interference of the sample and reference beams at the bottom surface (1) and the cross interference term (2). Both signals show phase fluctuations on the order of 10 nm, but the phase difference between signal 1 and 2 shows phase fluctuations corresponding to 180 pm, thereby demonstrating the improved phase stability.

III. F-DLS on Intralipid Particles in Solution

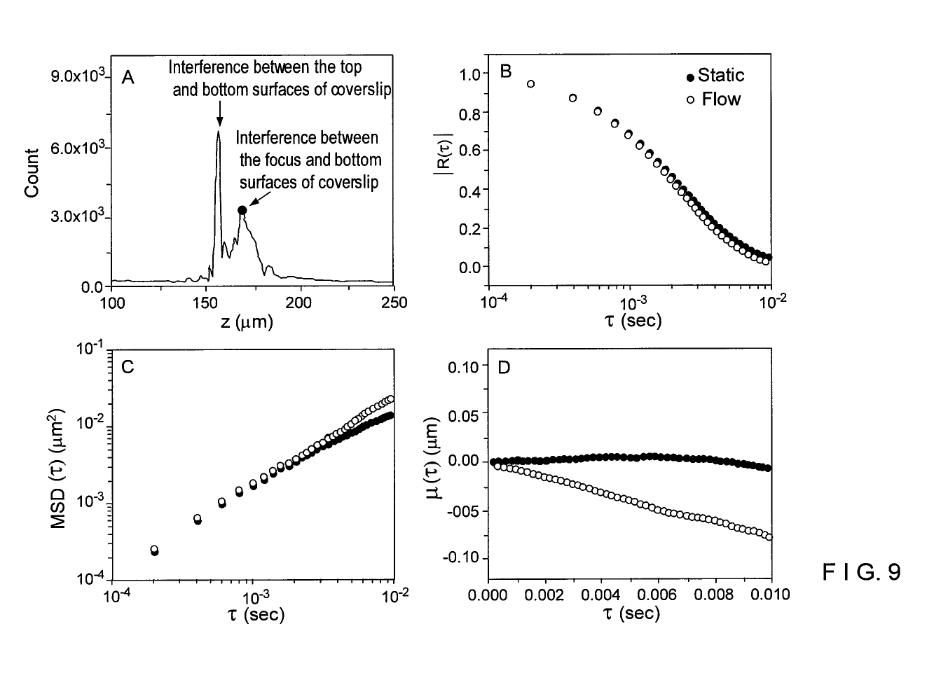

The validity of F-DLS analysis was assessed by examining dynamics of intralipid particles (Liposin, Hospira, Inc.) in distilled water. A 1% intralipid solution in a closed chamber and in a flow cell was measured to model the samples undergoing static and directional motions. FIG. 9A shows a graph of an exemplary depth-resolved intensity distribution obtained with an optical focus at ˜10 μm above the top surface of a base coverslip. The signal related to the interference between the bottom surface of the coverslip and focal volume could be identified by a short coherence gate, as indicated by the red dot. The F-DLS analysis has been performed based on the fluctuation of that interference signal recorded at a sampling rate of 10 kHz. FIG. 9B shows a graph of the exemplary magnitude of the autocorrelation function for the static and the flow cell measurements, which does not show a clear difference between two measurements. The MSDs were evaluated (Eq. 6), and fit with a power-law description (MSD˜Dτ^{α}). The exponents (α) were found as ˜1.08 for the static and ˜1.13 for the flow cell cases, respectively, and the increase was mainly due to the contribution from the directional motion. FIG. 9D shows the TADs calculated from the phase information of the autocorrelation function (Eq. 4). The intralipid particles in the static measurement exhibited no net time-averaged displacement, as expected for particles with an equal probability to move in all directions. However, a directional motion with an average velocity of −7.4 μm/sec was observed for the flow cell experiment.

IV. Velocity Correlation of Intracellular Dynamics

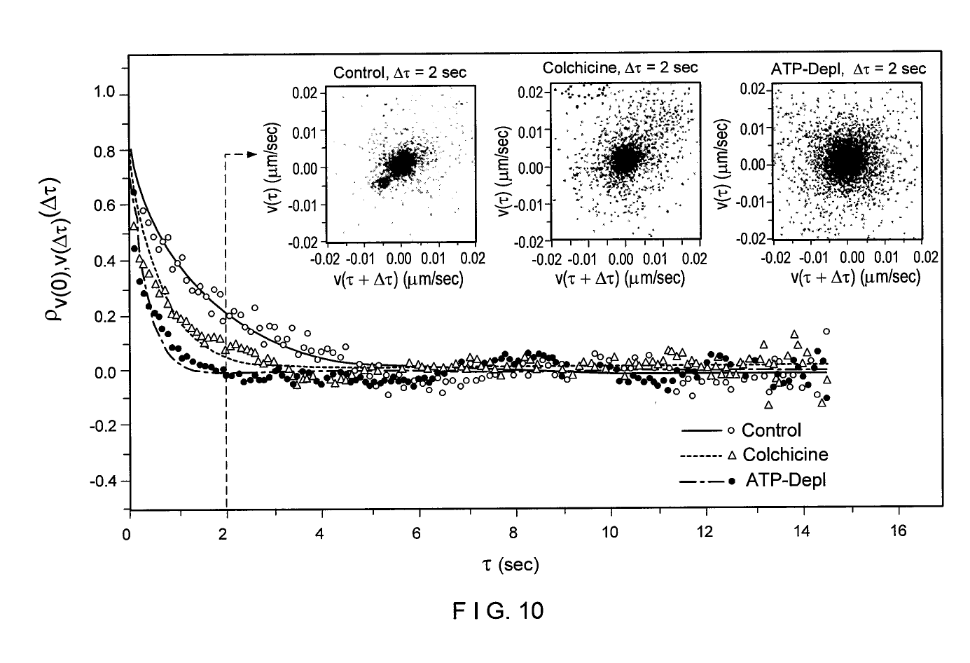

In order to investigate the coherence and modification in intracellular dynamics, F-DLS was applied to the intracellular dynamics measurement of human epithelial ovarian cancer cells (OVCAR-5). The cells were plated on collagen I-coated coverslip base dishes, and examined in a buffered medium at 37° C. We hypothesized that the introduction of Colchicine and ATP-depletion to control OVCAR-5 cells leads to disruption of coherence in intracellular motion. To test our hypothesis, we examined velocity correlation as a function of time-delay, Δτ, as described herein. If the intracellular dynamics is characterized by coherent directionality, the time-shifted velocity v(τ+Δτ) would be correlated with v(τ), but no correlation should be observed if the motion is random. FIG. 10 shows a graph of an exemplary velocity correlation of OVCAR-5 cells in different physiological conditions as a function of time-delay. We found that control cells are exhibited by a time-constant as ˜1.65 sec, but colchicine-treated and ATP-depleted cells have shorter time constants of ˜0.72 sec and ˜0.32 sec, respectively. The insets are the correlation diagrams at Δτ=2 sec in each case, which manifests the disruption of velocity correlation, or coherent intracellular motion by pharmaceutical interventions.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with imaging systems, and for example with those described in International Patent Application PCT/US2004/029148, filed Sep. 8, 2004, U.S. patent application Ser. No. 11/266,779, filed Nov. 2, 2005, and U.S. patent application Ser. No. 10/501,276, filed Jul. 9, 2004, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. An apparatus configured to propagate at least one electro-magnetic radiation, comprising:
at least one first arrangement configured to receive a first portion of the at least one electro-magnetic radiation directed to a sample and a second portion of the least one electro-magnetic radiation directed to a reference, the at least one first arrangement being structured to at least partially reflect and at least partially allow to transmit the first and second portions; and
at least one second arrangement configured to receive (i) a third portion of the at least one electro-magnetic radiation associated with at least one of the transmitted first portion or the reflected first portion from the sample and (ii) a fourth portion of the least one electro-magnetic radiation associated with at least one of the second transmitted portion of the least one electro-magnetic radiation or the reflected second portion from the reference, wherein the third and fourth portions travel at least partially along substantially the same path toward the at least one second arrangement, wherein the at least one second arrangement is further configured to at least one of:
i. receive the at least one of the reflected first and second portions which interfere with one another, and generate at least one signal which includes information associated with at least one fluctuation in an uncommon path of the first and second portions prior to a receipt thereof by the at least one first arrangement, or
ii. determine information regarding a spectrally resolved interference associated with the third and fourth portions.

2. The apparatus according to claim 1, wherein the at least one electro-magnetic radiation is generated by a broadband electromagnetic radiation source.

3. The apparatus according to claim 1, wherein the at least one electro-magnetic radiation is generated by an electromagnetic radiation source that has a tunable center wavelength.

4. The apparatus according to claim 1, wherein the at least one second arrangement is further configured to receive the at least one of the reflected first and second portions which interfere with one another, and generate at least one signal which includes information associated with at least one fluctuation in an uncommon path of the first and second portions prior to a receipt thereof by the at least one first arrangement.

5. The apparatus according to claim 1, wherein the at least one second arrangement is further configured to determine information regarding a spectrally resolved interference associated with the third and fourth portions.

6. The apparatus according to claim 1, further comprising at least one third arrangement which is configured to vary an angle of incidence of the at least one electromagnetic radiation on the sample.

7. The apparatus according to claim 1, wherein a waist of the first portion that is focused within the sample is about 0.5 μm or less.

8. The apparatus according to claim 1, wherein the at least one second arrangement is further configured to:
a. receive the at least one of the reflected first and second portions which interfere with one another, and generate the at least one signal prior to the receipt thereof by the at least one first arrangement, and
b. determine the information regarding the spectrally resolved interference associated with the third and fourth portions.

9. A method for propagating at least one electro-magnetic radiation, comprising:
receiving, using at least one first arrangement, a first portion of the at least one electro-magnetic radiation directed to a sample and a second portion of the least one electro-magnetic radiation directed to a reference, the at least one first arrangement being structured to at least partially reflect and at least partially allow to transmit the first and second portions; and
receiving, using a second arrangement, (i) a third portion of the at least one electro-magnetic radiation associated with at least one of the transmitted first portion or the reflected first portion from the sample and (ii) a fourth portion of the least one electro-magnetic radiation associated with at least one of the second transmitted portion of the least one electro-magnetic radiation or the reflected second portion from the reference, wherein the third and fourth portions travel at least partially along substantially the same path toward the at least one second arrangement, wherein the at least one second arrangement is further configured to:
a. receive the at least one of the reflected first and second portions which interfere with one another, and generate at least one signal which includes information associated with at least one fluctuation in an uncommon path of the first and second portions prior to a receipt thereof by the at least one first arrangement, or
b. determine information regarding a spectrally resolved interference associated with the third and fourth portions.

10. Computer-accessible medium which includes instructions, wherein, when the instructions are executed by a processing arrangement, the processing arrangement performs procedures comprising:
receiving first data associated with at least one electromagnetic radiation which is an interference between a first radiation obtained from a sample and a second radiation obtained from a reference; and
based on the first data, determining second data associated with a directional displacement of at least one object within the sample and third data associated with at least one diffusion property of the at least one object.

11. The computer-accessible medium according to claim 10, wherein, when executing the instructions, the processing arrangement generates at least one of the second data or the third data as a function of a time scale associated with a motion of the at least one object.

12. The computer-accessible medium according to claim 10, wherein, when executing the instructions, the processing arrangement generates the second and third data by an auto-correlation of the first data.

13. The computer-accessible medium according to claim 10,
wherein the first radiation is provided at a first location within the sample,
wherein, when executing the instructions, the processing arrangement receives further data associated with the at least one electromagnetic radiation which is an interference between a further radiation obtained from the sample and a second radiation at a second location within the sample which is different from the first location, and
wherein, when executing the instructions, the processing arrangement generates the second and third data based on the first and further data.

14. The computer-accessible medium according to claim 13, wherein the second and third data are generated by a cross correlation between the first data and the further data.

15. The computer-accessible medium according to claim 13, wherein, when executing the instructions, the processing arrangement resolves the directional displacement of the at least one object at the first and second locations as a function of time.

16. The computer-accessible medium according to claim 10, wherein the second data is determined based on a time correlation of a velocity of the at least one object within the sample.

17. The computer-accessible medium according to claim 10, wherein, when executing the instructions, the processing arrangement generates at least one signal which includes information associated with at least one fluctuation in an uncommon path of the first and second radiations.

18. The computer-accessible medium according to claim 10, wherein, when executing the instructions, the processing arrangement determines information regarding a spectrally resolved interference associated with the further data.

19. Computer-accessible medium which includes instructions for imaging at least one portion of a sample, wherein, when the instructions are executed by a processing arrangement, the processing arrangement performs procedures comprising:
receiving data associated with at least one electromagnetic radiation which is an interference between a first radiation obtained from a sample and a second radiation obtained from a reference; and
based on the data, generating at least one image associated with a directional displacement of at least one object within the sample and at least one diffusion property of the at least one object.

20. The computer-accessible medium according to claim 19, wherein each object is native to the sample.

21. The computer-accessible medium according to claim 19, wherein a waist of the first radiation that is focused within the sample is about 0.5 μm or less.

22. The computer-accessible medium according to claim 19, wherein, when executing the instructions, the processing arrangement generates the image by scanning the sample laterally and axially using the first radiation.

23. The computer-accessible medium according to claim 19, wherein the at least one image is at least one of a two-dimensional image, a three-dimensional image or a four-dimensional image.

24. The computer-accessible medium according to claim 19, wherein one of dimensions of the two, three or four-dimensional image is time.

25. The computer-accessible medium according to claim 19, wherein the second data is determined based on a time correlation of a velocity of the at least one object within the sample.

26. The computer-accessible medium according to claim 19, wherein, when executing the instructions, the processing arrangement generates at least one signal which includes information associated with at least one fluctuation in an uncommon path of the first and second radiations prior to a receipt thereof by at least one arrangement which is configured to at least partially reflect and at least partially allow to transmit the first and second radiations.

27. The computer-accessible medium according to claim 19, wherein, when executing the instructions, the processing arrangement determines information regarding a spectrally resolved interference associated with the data.

28. Computer-accessible medium which includes instructions for imaging at least one portion of a sample, wherein, when the instructions are executed by a processing arrangement, the processing arrangement performs procedures comprising:
receiving data associated with at least one electromagnetic radiation which is an interference between a first radiation obtained from a living organism and a second radiation obtained from a reference; and
based on the data, generating at least one image associated with at least one diffusion property of the living organism in which each object is native.

29. The computer-accessible medium according to claim 28, wherein the second data is determined based on a time correlation of a velocity of the at least one object within the sample.

30. The computer-accessible medium according to claim 28, wherein, when executing the instructions, the processing arrangement generates at least one signal which includes information associated with at least one fluctuation in an uncommon path of the first and second radiations prior to a receipt thereof by at least one arrangement which is configured to at least partially reflect and at least partially allow to transmit the first and second radiations.

31. The computer-accessible medium according to claim 28, wherein, when executing the instructions, the processing arrangement determines information regarding a spectrally resolved interference associated with the data.

32. Computer-accessible medium which includes instructions, wherein, when the instructions are executed by a processing arrangement, the processing arrangement performs procedures comprising:
receiving first data associated with at least one electromagnetic radiation which is an interference between a first radiation obtained from a sample and a second radiation obtained from a reference; and
based on the first data, determining second data associated with changes within the sample using a power spectrum of the at least one electromagnetic radiation based on an auto-correlation function.

33. The computer-accessible medium according to claim 32, wherein the second data is determined based on a time correlation of a velocity of at least one object within the sample.

34. The computer-accessible medium according to claim 32, wherein, when executing the instructions, the processing arrangement generates at least one signal which includes information associated with at least one fluctuation in an uncommon path of the first and second radiations prior to a receipt thereof by at least one arrangement which is configured to at least partially reflect and at least partially allow to transmit the first and second radiations.

35. The computer-accessible medium according to claim 32, wherein, when executing the instructions, the processing arrangement determines information regarding a spectrally resolved interference associated with the second data.
